(19) United States
(12) Patent Application Publication
(10) Pub. No.: US 2008/0140556 A1
(43) Pub. Date: Jun. 12, 2008

(54) MARKET-BASED METHOD AND SYSTEM FOR PRODUCING A RESERVE PRICE FOR AN AUCTION

(75) Inventor: Cristian Alfred Worthington, Vancouver (CA)

Correspondence Address: OYEN, WIGGS, GREEN & MUTALA LLP;480 - THE STATION, 601 WEST CORDOVA STREET, VANCOUVER, BC, V6B 1G1, omitted

(73) Assignees: 3801616 Canada Inc., Vancouver (CA); 6325971 Canada Inc., Vancouver (CA)

(21) Appl. No.: 11/608,195

(22) Filed: Dec. 7, 2006

(51) Int. Cl. G06Q 30/00; G06Q 40/00

(52) U.S. Cl. 705/37

(57) ABSTRACT

An interactive auction system allows a Seller to automatically establish the reserve price of an item being sold. The reserve price is established by means of a preliminary auction, in which bidders place standing bids based upon a general description of the quantity and quality of items that may be offered for sale in the future. Sellers can subsequently enter a specific item for sale. The value of the standing bids is then calculated and compared. The highest standing bid is selected and provided the Seller. The Seller then elects whether to accept the highest standing bid or use the highest standing bid as a reserve price for an auction.

### TECHNICAL FIELD

The invention relates to the field of auctions, and more particularly to methods for setting reserve prices in auctions.

### BACKGROUND

In a typical “reserve price auction” the party selling the item (“the Seller”), with or without the assistance of the auctioneer or an expert, establishes a price limit, called the “reserve price”, below which an item will not be sold. The reserve price is set prior to the auction taking place and can operate in one of two ways. First, the reserve price may be withheld. In that case the Seller can elect to keep the reserve price secret from bidders. Secondly, the reserve price may be published. The Seller can elect to advertise the reserve price to the bidders. In either the “withheld” or “published” scenario, if bidders do not meet or exceed the reserve price, the item being sold is withdrawn from the auction.

Sellers are confronted by several problems when establishing a reserve price. First, the Seller may not know the market price for the item being sold, which can result in an unrealistically low or high reserve price. Second, the Seller may not wish to rely on the auctioneer or other experts for advice on an appropriate reserve price since their suggested reserve price may be artificially low or high. For example, where the auctioneer earns a commission if the item is sold, the auctioneer may be inclined to set the reserve price lower than market forces dictate, to ensure a quick sale. Conversely, the auctioneer may give the Seller an artificially high reserve price, in the hope that the Seller will choose the auctioneer in question, rather than a competitor. Similarly, an expert may be inclined to set a higher reserve price for the item in order to flatter the Seller, or that reflects a retail price for the item. Thus, relying on the auctioneer or an expert can result in a reserve price that is not in line with market reality, which can lead to an unsuccessful auction.

Another problem with reserve prices is that the Seller may wish to have a firm offer in hand before the auction begins. This is particularly relevant in on-line auctions, where the Seller may wish to quickly establish the value of the item being sold. Also, when a Seller sets a reserve price (with or without the assistance of an auctioneer or expert advice), bidders may be inclined to be skeptical of the value being communicated to the auction in the form of the reserve price. In effect, the reserve price is seen as an arbitrary price that is more representative of the Seller's wishes than the true value of the item being sold. Further, Sellers often set the reserve price too high and thereby discourage potential bidders from bidding. This can have the result that no sale of the item occurs. An improved method for generating a reserve bid for an auction is therefore needed.

The foregoing examples of the related art and limitations related thereto are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

The present invention therefore provides an interactive auction system that allows a Seller to automatically establish the reserve price of an item being sold. The reserve price is established by means of a preliminary auction, in which bidders place standing bids based upon a general description of the quantity and quality of items that may be offered for sale in the future. Sellers can subsequently enter a specific item for sale. The value of the standing bids is then calculated and compared. The highest standing bid is selected and provided to the Seller. The Seller then elects whether to accept the highest standing bid or use the highest standing bid as a reserve price for an auction. Preferably the method is implemented by a computer network.

The method has particular application where the item to be auctioned is qualitatively predictable, that is, has a value which can be readily predicted from a number of well-defined parameters.

In addition to the exemplary aspects and embodiments described above, further aspects and embodiments will become apparent by reference to the drawings and by study of the following detailed descriptions.

### BRIEF DESCRIPTION OF DRAWINGS

Exemplary embodiments are illustrated in the referenced figure of the drawings. It is intended that the embodiments and figure disclosed herein are to be considered illustrative rather than restrictive.

FIG. 1 is a flowchart illustrating the invention.

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

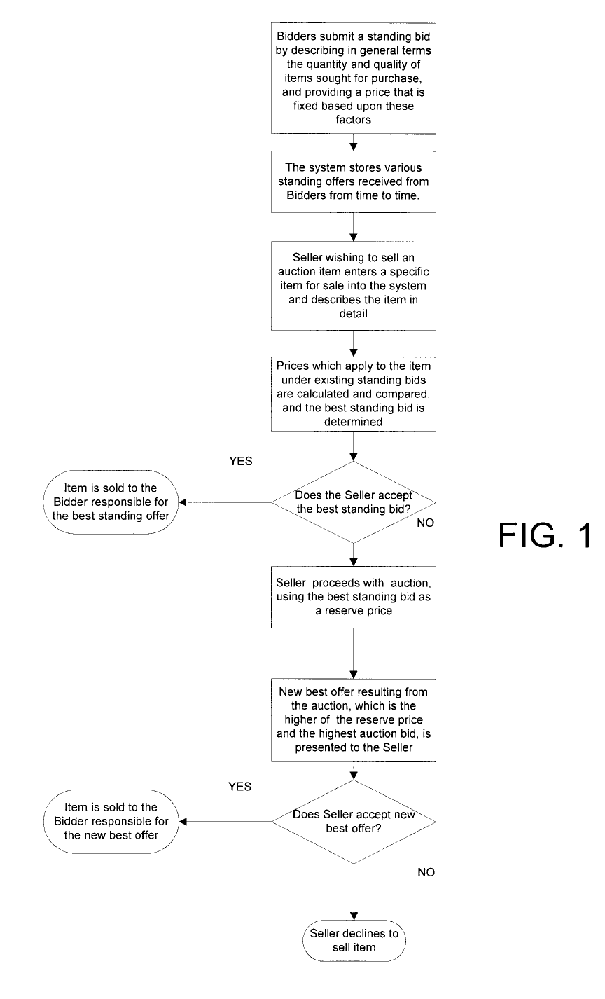

With reference to FIG. 1, the general method for an auction system according to the invention includes the following steps. In advance of an auction, potential bidders (“Bidders”) submit a standing bid or offer by describing in general terms the quantity and quality of items sought for purchase, and providing a price that is fixed based upon these factors. The system, preferably a computer system, stores the various standing offers received from Bidders from time to time. The standing bids are submitted “sight unseen”. That is, in submitting a standing bid, Bidders have no opportunity to examine the item which will be auctioned. Bidders can only define the quantity and quality of the items which they are willing to purchase for a predetermined price when they make a standing bid. Bidders agree that if their standing bid is successful, a seller of such an item can accept the standing bid and the Bidder is obligated to purchase the item at that price. The incentive for Bidders to provide a standing bid is that they are thereby guaranteed to have an opportunity to purchase all items having the defined characteristics which come up for auction. Bidders may withdraw their standing bid up until a Seller enters an item for sale in the auction which meets the criteria for the Bidder's standing bid.

The present method therefore has particular application where the item to be auctioned is qualitatively predictable. For purposes of this disclosure, an item is “qualitatively predictable” if the item's value will be largely independent of variations in quality from item to item and therefore it will have a market value which can be readily predicted from a number of well-defined parameters. Examples of qualitatively predictable items are commodities, financial instruments and securities, unused mass-produced consumer goods, vintage wines, personal services, airline tickets and hotel accommodation, and luxury goods.

Next, a Seller wishing to sell an auction item enters a specific item for sale into the system and describes the item in detail. The prices which apply to the item under the existing standing bids for the item being sold are calculated and compared, preferably by a computer algorithm, and the best standing bid is determined. The best standing bid is provided to the Seller, who may choose to accept the bid or place the item for auction using the best standing bid as a reserve price. If the Seller accepts the best standing bid, the item is sold to the Bidder responsible for the best standing bid and the purchase price is paid by the Bidder to the Seller, less a commission. In the event that the Seller chooses to proceed with the auction, using the best standing bid as a reserve price, the Seller is not bound to sell the item until the auction is completed and a new best offer is presented.

In the event that the Seller chooses to proceed with the auction, Bidders can then review the specific quality and quantity of the item being sold and can elect to improve upon their original bids based on the current market. The auction is conducted over a prescribed period of time. The auction can be conducted in a number of ways, including (but not limited to): a) a blind auction, in which each bidder bids once, bidders cannot see the bids of other bidders and the result is established when a time deadline is reached; or b) an iterative auction, in which bidders can see the bids placed by their competitors and can react by changing their bid.

When the auction is completed, the system presents the new best offer to the seller based on one of the following outcomes. If the auction has resulted in a higher price than the reserve price, the new price is offered to the Seller. If the reserve price has not been exceeded, the reserve price is left standing as the offer to be considered by the Seller. Thus, the price offered to the Seller is guaranteed to be no lower than the reserve price, which was established during the preliminary auction. The seller can elect to accept the new best offer or decline to sell the item.

According to one embodiment of the invention, this method can be applied to provide an auction for annuities. Annuities are financial instruments comprised of future payments of: a) varying quantity (payment sizes can vary depending on the specific terms of the annuity); b) varying frequency (payments can be weekly, monthly, yearly or lump sums); and c) varying quality (depending on the credit rating of the payor of the annuity). An auction of annuities according to the present invention can be constructed as follows. First, Bidders enter standing bids into a database, based upon a general description of annuities that may be offered for sale in the future. This can be done for example by the Bidders accessing an auction web site over the Internet using a web browser. The description of the annuities can be comprised of the following elements: a) Rate of Return. This is the effective interest rate represented by the price offered by the Bidder for annuities that fit the general description outlined below in b), c) and d). b) Range of Present Value. The Bidder can specify annuities with an upper and lower value that the bidder is willing to consider. The present value of a specific annuity depends upon the dates of the payments, the amounts of the payments and the interest rate. Buyers may have limited resources and may wish to limit the size of the annuity being purchased to fit within a budget or may wish to restrict their bids to larger annuities. c) Credit Rating of the Payor. Bidders can specify the credit rating of the insurance company paying the payments. Buyers can establish their risk tolerance, without knowing the specific identity of the payor. d) Maximum Term. The Bidders can specify the maximum length of time to the final payment in the annuity. The Bidder may wish to be assured that he/she will get all of his/her money back before a specific date.

For example, a specific Bidder can specify that he/she will bid the following: Effective Interest Rate: 8%; Credit Rating of Payor: A; Minimum Present Value: $50,000; Maximum Present Value: $450,000; Maximum Term: 20 Years. Owners of annuities who wish to sell their annuities for a lump sum may also visit a web site and describe their annuity payments on-line. The payments and the name of the insurance company are entered by the Seller. A computer based algorithm compares the specified annuity payments described by the Seller to the database of standing offers placed by Bidders. The best price is established by a computer based algorithm. The annuity Seller receives an instant price offer for the annuity, based upon this preliminary auction, and is presented with two options. The Seller can accept the offer in the form of the standing bid. Or the Seller can use the offer as a reserve price in an auction that will take place over a fixed period, say 48 hours, in which Bidders will have the option to examine the specific terms of the annuity and will have the opportunity to improve upon their standing bids. Whether the Seller chooses to accept the instant offer or waits for the 48 hour auction to elapse, the Seller will not be bound to sell the annuity unless he/she is satisfied with the price being offered. Under this system, a complex financial instrument (the annuity) can be instantly valued, based upon a parameter-driven database of standing bids. The subject annuity can then be offered for closer examination by the Bidders, who have the option to improve upon their bids once they have examined the identity of the payor and the payment details.

A system as described in this embodiment assures the Seller that a market-driven price is set at the onset of the auction and provides the seller with an instant estimate of the annuity's price. At the same time, this system allows for the function of an auction process, which ensures that the Seller is getting a better price for the annuity than would be likely under a system that sources money from a fixed pool.

This method of auctioning thus provides a number of benefits over conventional on-line or automated auctions. The Seller is able to get an instant appraisal of the value of his/her item, by describing the item to be sold and receiving instantaneously a reserve price that is backed up by a guaranteed offer to purchase at that price. The preliminary auction gives the Seller a market based appraisal of the item's value, without obliging the Seller to proceed with the sale and without inconveniencing the Bidders. The reserve price is set by the market, not by the Seller or the auctioneer or a third party expert, so the reserve price is more likely to reflect the state of the market at the moment the item is offered for sale, not the bias of the Seller or the auctioneer or a third party advising the Seller. The Seller is not placed in the position of taking a risk when he/she stipulates the reserve price, because the seller is not bound to sell at the reserve price. The Seller can choose to accept the sale at the reserve price, in order to achieve a quick sale, or proceed to see if Bidders will pay a higher price if given detailed information about the quality and quantity of the commodity being sold. The Seller is given the choice to sell immediately or wait to see if the market can improve upon the offer when the bidders are given more details about the item and more time. The process can be automated. The setting of the reserve price is driven by an automated process. Sellers are able to get instant results without having any foreknowledge of the market for the item being sold. The instant price offered by the preliminary auction can be used by the Seller as a market based appraisal of the item's value. The system thus allows Sellers to anonymously engage a market of potential buyers and receive a preliminary assessment of value in real time. The Seller can rely on the fact that he/she retains the option to walk away, if either the reserve price or the subsequent auction price is unsatisfactory. The Seller thereby enjoys much more control than he/she would in a conventional auction, while at the same time enjoying more accurate market information with which to make an informed decision.

The present method therefore provides a market-driven system for a) producing a reserve price that is seen to be credible by the Seller and the potential buyers; b) generating an instant appraisal of the item being sold; c) providing the Seller with a bona fide offer that can be accepted in lieu of the price determined by the auction; and d) establishing a starting point for the auction.

While the preferred system implements the method using a computer network, the method can also be implemented manually, in whole or in part. While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

What is claimed is:

1. A method of producing a reserve price for an item to be auctioned by a Seller, comprising the steps of:
i) obtaining one or more standing bids from one or more bidders whereby said bidders each agree to purchase an auctioned item having pre-defined characteristics for a value which can be determined by said pre-defined characteristics;
ii) storing said one or more standing bids received from bidders;
iii) said Seller providing the characteristics of said item to be auctioned which are required to calculate said value;
iv) calculating the value of said one or more standing bids, determining the highest standing bid and presenting said highest standing bid to said Seller;
v) said Seller choosing whether to accept said highest standing bid or to proceed with an auction using said highest standing bid as the reserve price.

2. A method of conducting an auction of an item to be auctioned by a Seller comprising the steps of:
a) producing a reserve price for said item by:
i) obtaining one or more standing bids from one or more bidders whereby said bidders each agree to purchase an auctioned item having pre-defined characteristics for a value which can be determined by said pre-defined characteristics;
ii) storing said one or more standing bids received from bidders;
iii) said Seller providing the characteristics of said item to be auctioned which are required to calculate said value;
iv) calculating the value of said one or more standing bids, determining the highest standing bid and presenting said highest standing bid to said Seller;
v) said Seller choosing whether to accept said highest standing bid or to proceed with an auction using said highest standing bid as the reserve price;
b) if said Seller proceeds with said auction, permitting said one or more bidders to examine said item to be auctioned and provide one or more new bids;
c) determining the new best offer resulting from the auction, being the higher of the reserve price and the highest new bid;
d) presenting said new best offer to the Seller.

3. The method of claim 1 wherein said item to be auctioned is qualitatively predictable.

4. The method of claim 3 wherein said item to be auctioned is a financial instrument.

5. The method of claim 3 wherein said item to be auctioned is a commodity.

6. The method of claim 4 wherein said item to be auctioned is an annuity.

7. The method of claim 6 wherein said characteristics of said annuity comprise rate of return, present value, credit rating of payor and term.

8. The method of claim 2 wherein said item to be auctioned is qualitatively predictable.

9. The method of claim 8 wherein said item to be auctioned is a financial instrument.

10. The method of claim 8 wherein said item to be auctioned is a commodity.

11. The method of claim 9 wherein said item to be auctioned is an annuity.

12. The method of claim 11 wherein said characteristics of said annuity comprise rate of return, present value, credit rating of payor and term.

13. The method of claim 1 wherein said steps are computer implemented.

14. The method of claim 1 wherein said Seller and said one or more bidders communicate with a computer processor via a computer network.

15. The method of claim 14 wherein said one or more standing offers are stored in a computer database.

16. The method of claim 15 wherein said calculation and determination are carried out by said computer processor.

17. The method of claim 2 wherein said steps are computer implemented.

18. The method of claim 2 wherein said Seller and said one or more bidders communicate with a computer processor via a computer network.

19. The method of claim 18 wherein said one or more standing offers are stored in a computer database.

20. The method of claim 19 wherein said calculation and determination are carried out by said computer processor.

21. A computer system for producing a reserve price for an item to be auctioned by a Seller, the system comprising:
a) a website and database maintained by a server accessible online to a plurality of users;
b) computer-implemented means for:
i) obtaining one or more standing bids from one or more bidders whereby said bidders each agree to purchase an auctioned item having pre-defined characteristics for a value which can be determined by said pre-defined characteristics;
ii) storing said one or more standing bids received from bidders;
iii) said Seller providing the characteristics of said item to be auctioned which are required to calculate said value;
iv) calculating the value of said one or more standing bids, determining the highest standing bid and presenting said highest standing bid to said Seller;
v) said Seller choosing whether to accept said highest standing bid or to proceed with an auction using said highest standing bid as the reserve price.

22. A computer system for conducting an auction of an item to be auctioned by a Seller, the system comprising:
A) a website and database maintained by a server accessible online to a plurality of users;
B) computer-implemented means for:
a) producing a reserve price for said item by:
i) obtaining one or more standing bids from one or more bidders whereby said bidders each agree to purchase an auctioned item having pre-defined characteristics for a value which can be determined by said pre-defined characteristics;
ii) storing said one or more standing bids received from bidders;
iii) said Seller providing the characteristics of said item to be auctioned which are required to calculate said value;
iv) calculating the value of said one or more standing bids, determining the highest standing bid and presenting said highest standing bid to said Seller;
v) said Seller choosing whether to accept said highest standing bid or to proceed with an auction using said highest standing bid as the reserve price;
b) if said Seller proceeds with said auction, permitting said one or more bidders to examine said item to be auctioned and provide one or more new bids;
c) determining the new best offer resulting from the auction, being the higher of the reserve price and the highest new bid;
d) presenting said new best offer to the Seller.

23. A computer program product comprising a memory having stored therein computer-executable instructions that when executed by a computer carry out the method of claim 1.

24. A computer program product comprising a memory having stored therein computer-executable instructions that when executed by a computer carry out the method of claim 2.
